(19) United States
(12) Patent Application Publication
(10) Pub. No.: US 2026/0333055 A1
(43) Pub. Date: Oct. 22, 2026

(54) SECURE ACTIVATION OF INTERNET-OF-THING DEVICES

(71) Applicant: The ADT Security Corporation, Boca Raton, FL (US)

(72) Inventor: James KNOX, Media, PA (US)

(21) Appl. No.: 19/180,434

(22) Filed: Apr. 16, 2025

(51) Int. Cl. H04W 12/72; G16Y 40/50; H04W 12/64

(52) U.S. Cl. CPC H04W 12/72; G16Y 40/50; H04W 12/64

(57) ABSTRACT

The present disclosure provides systems, methods, and apparatuses for the activation of Internet-of-Things (IoT) devices. The method includes receiving purchase information of an IoT device, where the purchase information comprises contact information of a user and a device identifier associated with the IoT device, in response to receiving a connection request comprising the device identifier, establishing a connection with the IoT device, creating an account for the user based on the contact information, generating an identifier associated with the IoT device, sending, by the platform system, a dynamic link to a user device, receiving, by the platform system, a confirmation that the user has opened the dynamic link via the user device, in response to the confirmation, associating, by the platform system, the IoT device to the account for the user, and activating, by the platform system, the IoT device using information within the account.

### TECHNICAL FIELD

Embodiments presented in this disclosure generally relate to device activation and, more specifically, to initiating an automated activation of Internet-of-Things (IoT) devices upon unboxing their packaging, with secure connections established between the devices and a control platform.

### BACKGROUND

Home security system have become increasingly popular as more homeowners seek to improve the safety and convenience of their living environments. These system often include a variety of sensors, such as cameras, motion detectors, and door/window alarms, which are deployed throughout the monitored space to detect and respond to potential security threats. In addition to these sensors, these systems also include a central control hub or base station installed at home. The central control hub acts as the command center to manage the connected devices and coordinate system operations.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example process of unboxing a base station, including powering on the station and initiating communication via a subscriber identity module (SIM) message, according to some embodiments of the present disclosure.

FIG. 2 illustrates an example sequence of interactions for IoT device activation using pre-registered user information, according to some embodiments of the present disclosure.

FIG. 3 illustrates an example sequence of interactions for IoT device activation without pre-registered user information, according to some embodiments of the present disclosure.

FIG. 4 depicts an example method for a base station to communicate with a platform and complete activation, according to some embodiments of the present disclosure.

FIGS. 5A and 5B depict an example method for a control platform to manage base station activation using pre-registered user information, according to some embodiments of the present disclosure.

FIGS. 6A and 6B depict an example method for a control platform to manage base station activation using geofences and time-boxed windows, according to some embodiments of the present disclosure.

FIG. 7 is a flow diagram depicting an example method for activating an IoT device for a registered user, according to some embodiments of the present disclosure.

FIG. 8 is a flow diagram depicting an example method for activating an IoT device for a retail user, according to some embodiments of the present disclosure.

FIG. 9 depicts an example computing device configured to perform various aspects of the present disclosure, according to some embodiments of the present disclosure.

FIG. 10 depicts an example computing device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method that includes receiving, by a platform system, purchase information of an Internet-of-Things (IoT) device, wherein the purchase information comprises contact information of a user and a device identifier associated with the IoT device, in response to receiving a connection request comprising the device identifier, establishing, by the platform system, a connection with the IoT device, creating, by the platform system, an account for the user based on the contact information, generating, by the platform system, an identifier associated with the IoT device, sending, by the platform system, a dynamic link to a user device, wherein the dynamic link comprises the identifier, receiving, by the platform system, a confirmation that the user has opened the dynamic link via the user device, in response to the confirmation, associating, by the platform system, the IoT device to the account for the user, and activating, by the platform system, the IoT device using information within the account.

One embodiment presented in this disclosure is a method that receiving, by a platform system, a connection request from an IoT device, where the connection request comprises location information of the IoT device, in response to the connection request, establishing, by the platform system, a connection with the IoT device, determining, by the platform system, a virtual boundary around the IoT device and a time-boxed window, receiving, by the platform system, an activation request from a user device to activate the IoT device, where the activation request comprises location information of the user device, determining that the user device is located within the virtual boundary and the activation request is received within the time-boxed window, in response to the determination, creating, by the platform system, an account for a user, generating, by the platform system, an identifier associated with the IoT device, sending, by the platform system, a dynamic link to the user device, wherein the dynamic link comprises the identifier, receiving, by the platform system, a confirmation that the user has engaged the dynamic link via the user device, in response to the confirmation, associating, by the platform system, the IoT device to the account for the user, and activating, by the platform system, the IoT device using information within the account.

One embodiment presented in this disclosure provides a packaging of an IoT device, including a battery tab attached to a lid of the packaging, and a subscriber identity module (SIM) card integrated within the IoT device. When the packaging is opened by a user, the battery tab is automatically pulled from the IoT device, activating a battery to power on the IoT device, and upon being powered on, the IoT device activates the SIM card to send a connection request to a platform system to initiate an activation process.

### Example Embodiments

Home security systems have become increasingly popular, with the central control hub or base station serving as the command center to manage sensors installed throughout the monitored environment. Despite the growing popularity, activating and setting up the base station can be a significant challenge for many customers. A common issues is that the activation process for the base station or control hub is often complicated and difficult to follow.

Typically, the activation process requires users to unpack the device, manually connect it to a network, and configure multiple settings to enable communication with the platform and associated sensors. For customers unfamiliar with technical setups, this can result in confusion or even failure to complete activation, ultimately leading to reduced activation rate. Additionally, this complexity contributes to a higher product return rate, as customers who cannot complete the activation process may decide to return the product.

The present disclosure addresses these challenges and other related concerns by providing methods, systems, and apparatuses to streamline the IoT device activation process. One embodiment of the present disclosure introduces a packaging design for IoT devices, specifically the base station of a home security system. The packaging incorporates a battery tab, with one end attached to the lid of the box and the other end connected to the battery compartment of the base station. When the packaging remains closed, the battery tab isolates the battery (or batteries) by preventing the battery (or batteries) from making contact with one or more electrical terminals of the device. Upon opening the packaging, the battery tab is automatically removed, which enables the battery (or batteries) to connect and power on the base station without requiring any additional actions from the user.

Another embodiment of the present disclosure provides methods and systems for activating the base station through a control platform. When the base station is powered on, such as through the opening of the packaging, the base station sends a connection request to the control platform via an integrated SIM card. Upon receiving this request, the platform establishes a secure connection with the base device, creates a platform account for the user, and generates a universal unique identifier (UUID) for the base station. In embodiments where user information is pre-registered, such as during online purchase, the platform uses this pre-stored information to create the platform account for the user. With the user information and the assigned UUID, the platform sends an activation message containing a dynamic link to the user's device. The dynamic link includes the UUID assigned to the current base station. Once the user opens the link, a response is sent back to the platform, which associates the platform account with the UUID and other relevant information of the base device. Following that, the platform sends an activation command to the base station, activating the base device and completing relevant settings. In some embodiments, the dynamic link may further direct the user to download a software application or visit a website where the user can register a user account. Once the link is opened and the user account has been created, the platform may associate the user account with the platform account, and use information within both accounts to configure the base station's settings.

For retail (e.g., in-person) purchasers and/or for purchases where user information is not pre-registered, in some embodiments, the connection request sent via the SIM card includes the location of the base station. The platform may determine a geofence and/or a time-boxed activation window based on this location information. The platform can then validate whether an activation request received from the user's device falls within the geofence and/or the time-boxed window. Upon successful validation, the platform assigns a UUID to the base station, creates a platform account for the user, and sends an activation message containing a personal identification number (PIN) to the user's device. Once the code is entered on the base station, the platform receives the activation confirmation message, associates the base with the platform account, and completes the activation operation.

The disclosed embodiments provide a streamlined activation process by automating power-on through packaging design and simplifying the interactions between the base station and the control platform. The disclosed approach reduces the complexity in the activation process by minimizing (or at least reducing) the need for manual inputs from the user, and therefore improves the overall user experience.

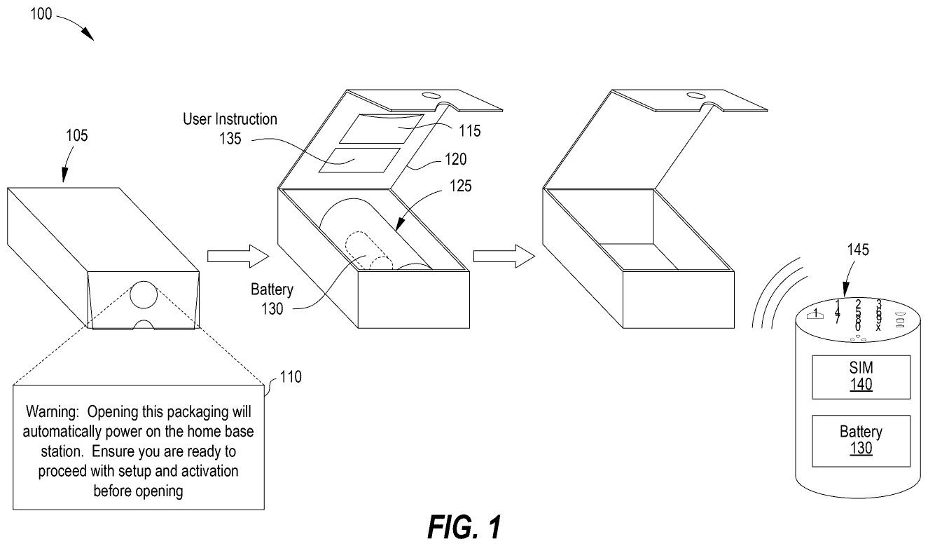

FIG. 1 illustrates an example process 100 of unboxing a base station, including powering on the station and initiating communication via a subscriber identity module (SIM) message, according to some embodiments of the present disclosure.

As depicted, the base station (also referred to in some embodiments as the control hub) is packaged inside the closed box 105. A warning label 110 is attached to the outside of the box 105, notifying the user (or customer) with the following example message: “Opening this packaging will automatically power on the home base station. Ensure you are ready to proceed with setup and activation before opening.” The warning label 110 informs the user (or customer) of the automatic activation feature.

When the user opens the box, a battery tab 115 is pulled off from the battery compartment 130 of the base device 125. As illustrated, the battery tab 115 is designed with one end connected to the lid 120 and the other end attached to the battery compartment 130. The battery tab 115 prevents the battery (or batteries) within the compartment 130 from making contact and powering the device while the box remains closed. As the lid 120 is lifted, the battery tab 115 is automatically removed from the battery compartment 130, which enables the battery to power on the device 125. As depicted, the lid 120 includes an additional instruction 135 to guide the user through the activation process. In some embodiments, the user instruction 135 may include a quick response (QR) code that the user may scan to download a mobile application or access a website. Through this app or website, the user may register a user account and provide his or her contact information (e.g., email, phone number, home address) and preferences (e.g., notification preferences).

Once the base station 125 is powered on, as depicted, the user removes the device 125 from the box 105 and places the device 125 in a location within the monitored environment for installation and activation. In some embodiments, the location for installing the base device may be determined by the user (e.g., the homeowner). In some embodiments, installation instructions may be printed on the packaging or accessed through a website or mobile application. The instructions may provide additional guidance to help the user determine the optimal location for installation. The base station includes a keypad 145 on its surface. In some embodiments, the keypad 145 may be used for user interaction and support functions, such as entering security codes, managing device settings, or controlling connected sensors.

Inside the base station 125, the pre-installed battery 130 is now active, providing power to the unit. Additionally, the base device 125 includes an integrated SIM card 140. The SIM card 140 enables cellular connectivity and is configured to send a connection request automatically once the device 125 is powered on. In some embodiments, the control request may be transmitted to a control platform and initiate the process for activating the base station 125.

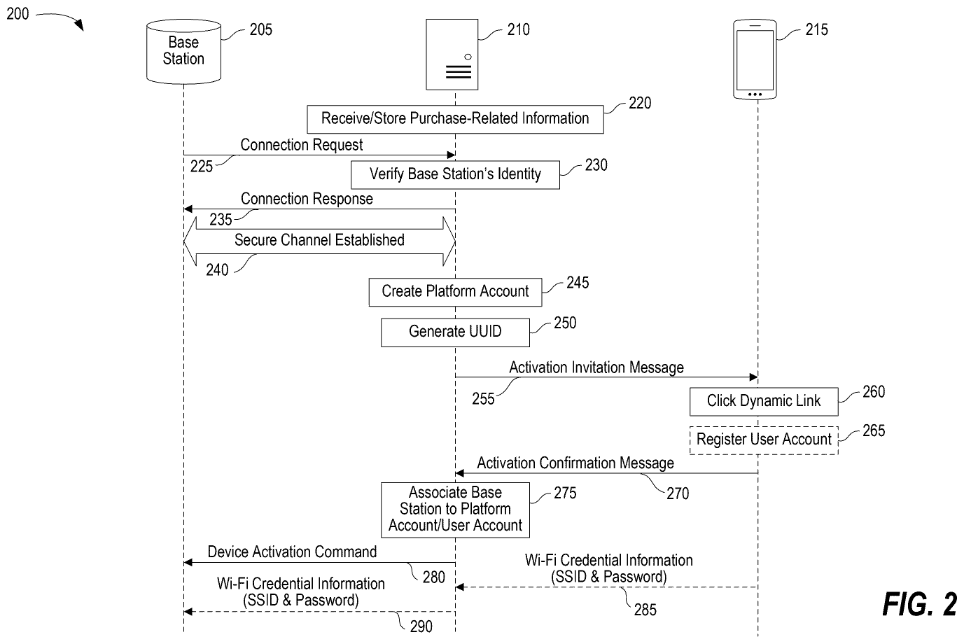

FIG. 2 illustrates an example sequence of interactions 200 for IoT device activation using pre-registered user information, according to some embodiments of the present disclosure.

The example sequence of interactions 200 is configured for embodiments where user (or customer) information is pre-registered on the platform, such as through online purchases, subscription-based services, or other circumstances where the users have provided their information beforehand. In these embodiments, upon receiving the connection request from a base device, the platform may use the pre-stored data to determine whether the device sending the request is authorized and associated with a known user (or customer). This approach allows the platform to proceed directly with the activation process without requiring additional verification steps or manual inputs from the user. As used herein, the IoT device refers to the base station 205. In some embodiments, the IoT device may further include intelligent sensors installed in the monitored environment (e.g., the user's home). A similar activation process may be applied to activate and connect these devices into the overall security monitoring system.

As depicted, the control platform 210 receives and stores purchase-related information (step 220). This information may be obtained through various formats, such as online purchases, subscription-based services, or other transactions where the user (or customer) provides their contact details at the time of purchase. In some embodiments, the purchase-related information may also be referred to as transaction information or transaction data. In some embodiments, the stored data may include the purchaser's contact information (e.g., email, phone number, home address) and device-specific details for the base station (e.g., serial number, stock keeping unit (SKU), international mobile equipment identify (IMEI), media access control (MAC) address). As used herein, the control platform 210 refers to a centralized system configured to manage the activation, communication, and configuration of IoT devices (e.g., the base station 205 or other home security sensors). In some embodiments, the control platform 210 may be implemented as a single server or computing system. In some embodiments, the control platform 210 may be designed as a distributed architecture including multiple interconnected servers and database that work in conjunction to support the device activation and configuration processes and coordinate further operations. In some embodiments, the control platform may be deployed as a physical device located on-premises. In some embodiments, the control platform may be cloud-based, using cloud computing resources to support device activation and ongoing operations.

Following the purchase, the base device 205 is shipped or otherwise provided to the user (e.g., mailed to the address provided by the user (or customer) at the time of purchase). During transit, the package is closed, and the base station 205 remains unpowered as the battery tab (e.g., 115 of FIG. 1) prevents the battery (or batteries) from making contact with one or more electrical terminals of the device. When the user (or customer) receives the package and opens it, the battery tab is automatically removed as part of the packaging design, and the base station 205 is powered on without requiring any manual actions from the user (or customer).

The base station 205 also includes an integrated SIM card (e.g., 140 of FIG. 1). Once the base station 205 is powered on, the SIM card is automatically activated and sends a connection request 225 to the control platform 210 to initiate the activation process. The connection request 225 may include information related to the base station, such as the base station's serial number or MAC address (which helps the platform to recognize and authenticate the device) and the device's location data (e.g., GPS coordinates) (which enables the platform 210 to determine the device's geographic location). Other relevant data, such as firmware version or network information, may also be included to provide the platform more context and facilitate an efficient activation process.

Upon receiving the connection request, the platform verifies the device's 205 authentication and identity by comparing the provided information (e.g., serial number, IMEI, SKU, or MAC address) with pre-stored data (step 230). This step is to confirm that the base station 205 is authorized for activation and associated with an existing user (or customer). In some embodiments, the determination that the base station is authorized for activation may involve the platform confirming that the base station is part of the inventory that has been sold and shipped to a customer. The platform may use pre-stored data, such as the serial number of the device, to verify that the device is an authorized unit (and not a counterfeit). In some embodiments, the confirmation that the base station is associated with an existing user (or customer) may involve the platform 210 verifying that the serial number or other unique identifiers provided in the connection request matches the data linked to a specific customer's contact information stored in the platform. After successful verification, the control platform 210 sends a response 235 back to the base station 205. The response 235 may include an acknowledgement of the request and additional data, such as security credentials or tokens, which are required to establish a secure communication channel.

Following the exchange, a secure channel 240 is established between the base device 205 and the control platform 210. In some embodiments, the channel may be built using protocols like HTTPS, TLS, or similar, which encrypt all transmitted data to protect sensitive information during the activation process (e.g., exchange of activation commands or user-specific configurations).

After the communication channel is established, the control platform 210 proceeds to create a platform account for the user (or customer) based on the pre-stored purchase-related information (step 245). The platform account serves as an active profile that the control platform 210 may use to manage and interact with the base station and other connected devices (e.g., home security sensors). In some embodiments, the platform account may be created before the connection request 225 is received, such as at the time the platform 210 first receives the purchase-related information (e.g., during an online transaction or subscription registration). The preemptive account creation may further streamline the activation process by allowing the platform 210 to immediately associate the base station 205 with the user's existing profile as soon as the connection request is verified.

The platform 210 also assigns a UUID for the base station 205 that has sent the connection request (step 250). The UUID serves as a globally unique reference for the device 205 within the platform's ecosystem. The platform 210 may then use the UUID to track and manage the base station 205 in future interactions.

After creating the platform account and assigning the UUID, the platform 210 sends an activation message 255 to the user's device 215 (e.g., mobile phone, laptop, tablets, or other IoT devices) using the contact information provided at the time of purchase (e.g., email address, phone number). The message 255 contains a dynamic link that guides the user through the activation process. Once the user opens the link, a confirmation message 270 is automatically sent back to the platform 210, indicating that the activation request has been approved by the user. In some embodiments, the dynamic link may refer to a URL that includes the UUID assigned to the requesting base station 205. The UUID serves as a query parameter, allowing the platform to recognize and associate the specific base station 205 with the user's account.

In some embodiments, the dynamic link may further direct the user to download a software application or visit a website. Through these interfaces, the user may register a user account (step 265), and use this account to manage the base station 205 and adjust its configurations (e.g., setting up a passcode, customizing security settings, or managing connected devices or sensors).

As depicted, once the platform 210 receives the confirmation message 270, the platform 210 links the base station 205 (identified by the UUID) to the platform account (step 275). In embodiments where a user account is also registered (e.g., through a software application or a website), the platform 210 may associate the base station 205 and the platform account with the user account.

After completing these associations, the platform 210 sends an activation command 280 to the base station 205. The activation command instructs the base station 205 to operate as part of the IoT system (e.g., home security system). During this process, in some embodiments, the platform 210 may use information stored in the platform account and/or user account to configure the base station 205. For example, user-specific preferences, such as time zone settings, notification preferences (e.g., push alerts, email updates), or default device behavior (e.g., arming modes for the security system), may be applied. Additionally, the platform 210 may use shared user-specific location data (e.g., GPS coordinates of the home) to optimize location-based features (e.g., geofence or local alert configurations). Security settings like encryption keys, access passcodes, or two-factor authorization requirements may also be sent to the base station 205, configuring the device to operate within a secure framework adapted to the user's needs.

In some embodiments, after activating the base station 205, the platform 210 may receive Wi-Fi credentials (e.g., service set identifier (SSID) and password) from the user's device 215 (step 285). These credentials may be provided through a software application or website. Once the platform 210 receives these credentials, the platform 210 may forward the data to the base device 205 (step 290). Upon receiving the Wi-Fi credentials, the base device 205 may use the provided information to connect to the specified Wi-Fi network (e.g., the Wi-Fi installed in the monitored environment). Once connected to the network, the base device may confirm the connection status to the platform 210. In some embodiments, the base device 205 may switch from cellular connection (e.g., via the integrated SIM card) to Wi-Fi for ongoing communication.

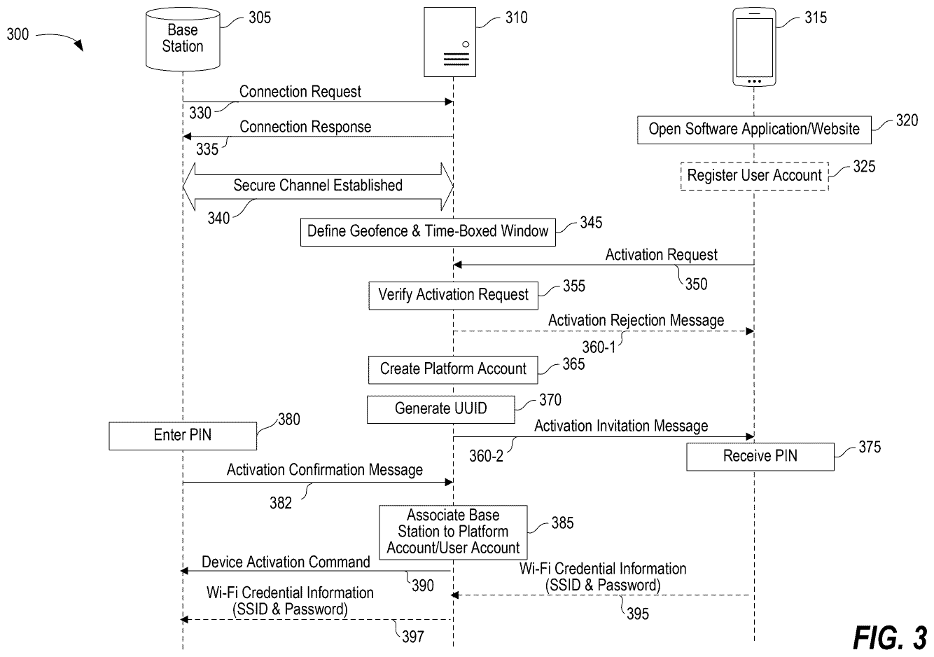

FIG. 3 illustrates an example sequence of interactions 300 for IoT device activation without pre-registered user information, according to some embodiments of the present disclosure.

The example sequence of interactions 300 is designed for embodiments where user information is not available and therefore cannot be pre-registered or saved in the platform 310. This is common for retail customers who purchase the product off-the-shelf or through other channels where contact information is not collected during the transaction. In such configurations, since no pre-stored data is provided, the platform, upon receiving a connection request from a base station 305, cannot verify whether the device is authorized for activation or whether it is associated with a specific customer. To address this limitation and other concerns, the platform 310 uses a geofence and/or a time-boxed activation window. These mechanisms provide that only devices within a specific geographic area (e.g., a virtual boundary around the base station like 50-meter radius) and/or within a predefined time frame (e.g., a period of time defined by the activation window like 15 minutes from when the connection request is received from the base station) may proceed with the activation process. As used herein, the IoT device refers to the base station 305. In some embodiments, the IoT device may further include intelligent sensors installed in the monitored environment (e.g., the user's home). A similar activation process may be applied to activate and connect these devices into the overall security monitoring system.

As depicted, the base station 305 sends a connection request 330 to the platform 310. This request 330 is automatically sent via an integrated SIM card (e.g., 140 of FIG. 1) when the packaging of the base station is opened. The connection request 330 may include the location data of the base station (e.g., GPS coordinates) and device-specific identifiers (e.g., serial number, SKU, IMEI, MAC address).

The platform 310 responds to the base device 205 with a connection response 335. During this step, the platform may use the identifier included in the request to verify whether the device is authorized and not a counterfeit. However, since no contact information is pre-stored, the platform cannot determine whether the base station sending the request has been sold to a specific customer. Given this limitation, the platform 310 proceeds by sending a connection response 335 to establish communication with the base station without associating it with any specific user at this stage. In some embodiments, the response 335 may include an acknowledgement of the request and security credentials or tokens needed to establish a secure communication channel.

Following the exchange, a secure communication channel 340 between the base station 305 and the control platform 310 is established. In some embodiments, the channel may be established using encrypted protocols, such as HTTPS, TLS, or the like. Once the connection is established, the platform 310 then uses the shared location information of the base station 305 to define a geofence and/or a time-boxed activation window (step 345). As used herein, a geofence refers to a virtual boundary around the base station's location (e.g., 50-meter radius), determined using GPS or other location-based data. A time-boxed window refers to a specific period during which received activation requests are considered valid. The time-boxed window may start when the platform receives the connection request from the base station (e.g., 15 minutes). These two parameters are set to ensure that only devices sending activation request from within the defined geofence and during the specific time frame are verified as authorized for activation. Devices meeting these criteria may proceed with further activation steps, while requests outside the boundary or timeframe are rejected. In some embodiments, the size of the geofence and the time limit in the activation window may be adjusted based on the system requirements and/or user-defined parameters.

The packaging of the base station 305 (or the base station 305 itself) may include additional instructions, such as a QR code, directing the retail customer to download a software application or visit a website to initiate the activation process. The software application or website is connected to the platform 310. In parallel with or subsequent to unboxing the base station 305, where the connection request 330 is automatically sent to the platform 310, the user may use his or her device 315 (e.g., mobile phone) to scan the QR code to access the application or website. Through these interfaces, an activation request 350 is sent to the platform 310. In some embodiments, the activation request 350 may share the location data of the user's device 315, which provides additional context for device verification. In some embodiments, the user may register a user account through the application or website, and provide his or her contact details (e.g., email, phone number, home address) and preferences (e.g., time zone settings, notification preferences, security settings) to the platform 310.

Upon receiving the activation request 350, the platform verifies the request by cross-referencing the shared data (step 355), such as the user device's 315 location, with the defined geofence and/or time-boxed window. As discussed above, the geofence is a virtual boundary defined based on the location data of the base station 305, and the time-boxed window defines a specific temporal interval during which activation request are considered as valid. If the location of the user device 315 falls within the geofence, this indicates that the user device 315 is in proximity to the base station 305. The two parameters are implemented to ensure that the activation request originates from an authorized user device 315. By restricting activation to devices within the defined geographic range and a specific time frame, the platform 310 reduces the risk of unauthorized or erroneous associations.

If the request is sent within the time-boxed window and the location of the user device 315 falls within the geofence, the platform 310 proceeds with the activation process. However, if the request is sent outside the time-boxed window or the user device's 315 location falls outside the geofence, the platform 310 sends a rejection message 360-1 to the user device, notifying the use of the invalid activation attempt. In some embodiments, the rejection message may further include instructions to resend the activation request, such as moving the device 315 closer to the base station to ensure the device location falls within the defined geofence, or rebooting the base station 305 to reset the time-boxed window. In some embodiments, the base station 305 may be rebooted by manually turning the device off and on again, which prompts the base station 305 to resend a connection request to the platform 310 and therefore reinitializes the activation process with a new time-boxed window.

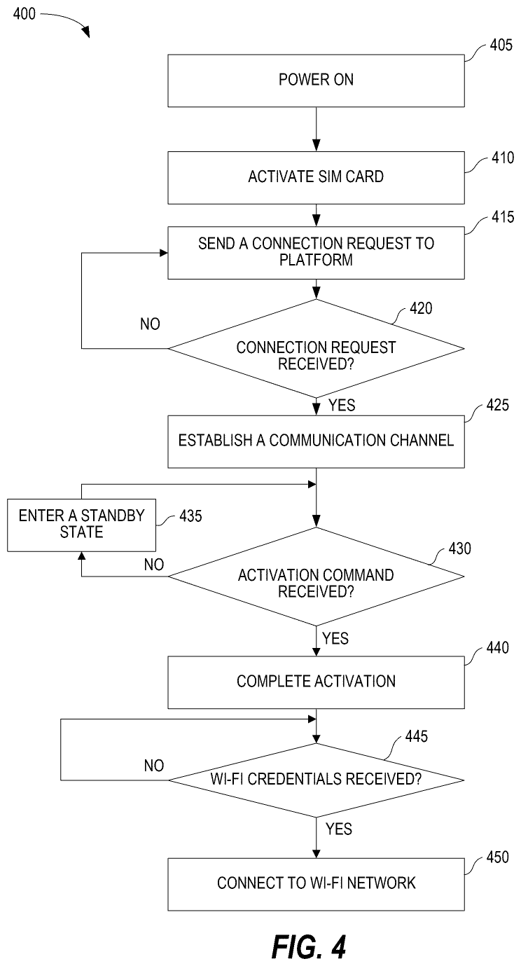

If the activation request is valid, the platform 310 proceeds with the activation process by creating a platform account for the user (step 365). The platform account serves as a centralized and active repository for managing the base station 305 and any associated devices within monitored environment (e.g., door/window alarms, smoke/carbon monoxide sensors, motion detection sensors, LiDAR-based sensors). The platform 310 also assigns a UUID to the requesting base station 305 (step 370). The UUID servers as a unique reference for tracking and managing the device 305 throughout the device's lifecycle within the platform 310. After the UUID is assigned, the platform 310 generates an activation invitation message 360-2, which may include either a personal identification number (PIN) or a dynamic link (e.g., URL). The activation invitation message is then sent to the user's device 315 through various communication channels, such as through text message, email, app notifications, or other suitable formats. If the message contains a dynamic link, once the user clicks the link, an activation confirmation message is automatically sent back from the mobile device to the platform, indicating that the user has engaged with and approved the activation process. In embodiments where the message 360-2 includes a PIN (step 375), the user manually enters the code on the base station 305 (e.g., 125 of FIG. 1) via its integrated keypad (e.g., 145 of FIG. 4) (step 380). The base station 305 then sends a confirmation message 382 back to the platform 310 for verification.

Upon receiving the confirmation message and completing the verification (e.g., confirming that the entered PIN matches the code sent by the platform), the platform 310 proceeds to associate the platform account with the base station 305 (identified by the UUID) (step 385). In embodiments where a user account is created during the activation process, the platform 310 may further associate the base station 305 and platform account with the user account to maintain a unified and secure management structure. After completing these associations, the platform 310 sends an activation command 390 to the base station 305, instructing the device to switch from its initial setup state to operational status. As part of the activation process, in some embodiments, the platform 310 may further configure the base station's 305 settings using information stored in the platform account and/or user account. These configurations may include setting the appropriate time zone, defining notification formats and frequencies, and optimizing location-based features.

In some embodiments, the user may share Wi-Fi credential data (e.g., SSID and password) to the platform 310 (e.g., via the mobile app or website) (step 395). The platform 310 may then forward the data to the base station 305 (step 397). Upon receiving the Wi-Fi credentials, the base station 305 may use this information to establish a connection to the specified Wi-Fi network (e.g., home Wi-Fi). Following the successful connection, the base device 305 may convey the connection status to the platform 210, and transition from relying on the cellular SIM card for communication to using the Wi-Fi network for all subsequent interactions with the platform 310.

FIG. 4 depicts an example method 400 for a base station to communicate with a platform and complete activation, according to some embodiments of the present disclosure. In some embodiments, the depicted example method 400 may be implemented by one or more computing devices or systems, such as the base station 125 as depicted in FIG. 1, the base station 205 as depicted in FIG. 2, and the base station 305 as depicted in FIG. 3.

At block 405, the base station (also referred to in some embodiments as a control hub) (e.g., 125 of FIG. 1) is powered on. In some embodiments, the device may be automatically powered on during unboxing, such as through the removal of a battery tab (e.g., 115 of FIG. 1) that connects the battery (or batteries) to the device's power system. In some embodiments, the device may be manually started by the user, such as by pressing a power button or connecting it to a power source. Once powered on, the base station initializes its internal system and prepares for activation.

At block 410, the base station activates a SIM card (e.g., 140 of FIG. 1). The SIM card is pre-installed in the device and configured for cellular communication.

At block 415, the base station sends a connection request (e.g., 225 of FIG. 2 or 330 of FIG. 3) to the platform (e.g., 210 of FIG. 2 or 310 of FIG. 3) using the activated SIM card. The connection request may include information like the device identifier (e.g., serial number) and location data (e.g., GPS coordinates).

At block 420, the base station waits and checks whether a response (e.g., 235 of FIG. 2 or 335 of FIG. 3) is received from the platform. If a response is received, the method 400 proceeds to block 425. The response may include an acknowledgement confirming the reception of the request, and may provide additional information for establishing a secure communication channel with the platform (e.g., encryption keys, session tokens). If no response is received, the base station continues to wait. In some embodiments, the base station may periodically resend the connection request to the platform at predefined intervals. If the retries exceed a certain threshold without success, the base station may enter a standby state to conserve power while continuing to monitor for incoming responses. If the base device contains a user interface, such as LEDs or a display screen, the base station may display a notification on the user interface, prompting the user to check network conditions and/or retry the process manually.

At block 425, a secure communication channel is established between the platform and the base station. In some embodiments, encryption protocols like HTTPs or TLS may be used to protect the communication.

At block 430, the base station checks if an activation command (e.g., 280 of FIG. 2 or 390 of FIG. 3) has been received from the platform. For embodiments where purchase information is pre-stored on the platform (e.g., online purchases), the platform may match the base station's identifier (e.g., serial number) with pre-stored data. If a match is found, the platform may generate a UUID for the base station, and create an activation invitation message (e.g., 255 of FIG. 2) containing a dynamic link embedded with the UUID. The dynamic link may be sent to the user using the registered contract information, and once the link is clicked, a confirmation (e.g., 270 of FIG. 2) may be automatically sent back to the platform. Upon receiving the confirmation, the platform may generate and send an activation command (e.g., 280 of FIG. 2) to the base station.

For embodiments without pre-stored purchase information (e.g., retail purchases), the activation process may define a geofence and/or a time-boxed window based on the location data received in the connection request from the base station. The user may access the platform via a software application or website (e.g., by scanning a QR code from the packaging) to register a user account and send an activation request (e.g., 350 of FIG. 3). If the activation request is received with the geofence and time-boxed window, the platform may create a UUID for the base station and send a PIN to the user's device (e.g., 315 of FIG. 3) for confirming activation. Once the confirmation (e.g., 382 of FIG. 3) is received and the verification is completed (e.g., confirming that the entered PIN matches the code sent by the platform), the platform may send an activation command (e.g., 390 of FIG. 3) to the base station.

If the activation command is received, the method 400 proceeds to block 440, where the base device applies the activation settings (e.g., linking to the user account, linking to the platform account, initializing IoT functionalities) and transitions to an active operational status.

If no activation command is received, the method proceeds to block 435, where the base station enters a standby state to conserve energy. In some embodiments, the base station may periodically retry the activation process by resending an additional request to the platform. If a defined period of time passes without receiving an activation command, the base station may display a notification on its user interface (e.g., an LED indicator, display screen, or audio prompt). The notification guides the user to check the activation status and complete the verification process manually if needed.

At block 445, after activation, the base station checks whether Wi-Fi credentials are received from the platform. These credentials, such as the SSID and password, may be provided by the user through a software application or website. If Wi-Fi credentials are received, the method 400 moves to block 450, where the base station uses the provided credentials to connect to the specified Wi-Fi network within the monitored environment (e.g., the user's home). Upon successful connection, the base device may transition from cellular communication to Wi-Fi for all subsequent interactions with the platform. Additionally, through the Wi-Fi network connection, the base device may communicate with other IoT devices in the monitored environment (e.g., security cameras, door/window alarms, motion sensors) and facilitate coordinated actions across the home security system. If no such Wi-Fi credentials are received, the base station continues to rely on cellular network for communication (e.g., via the integrated SIM card).

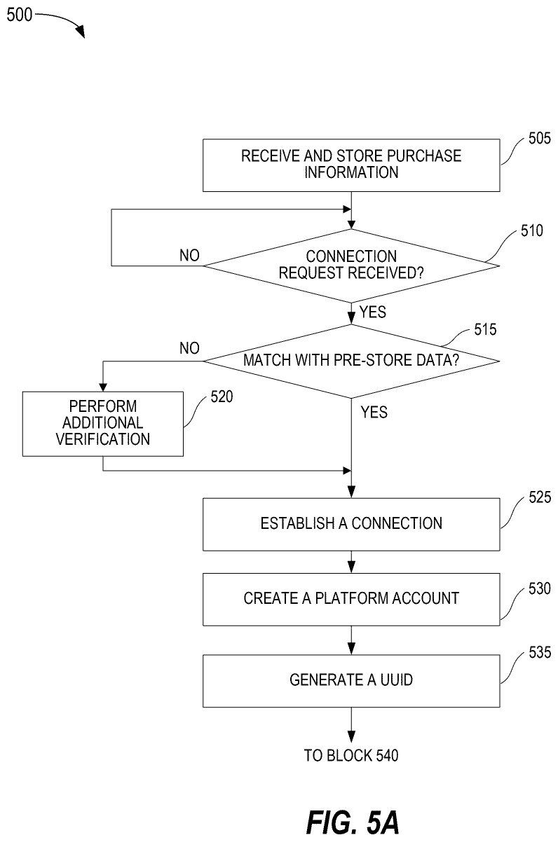

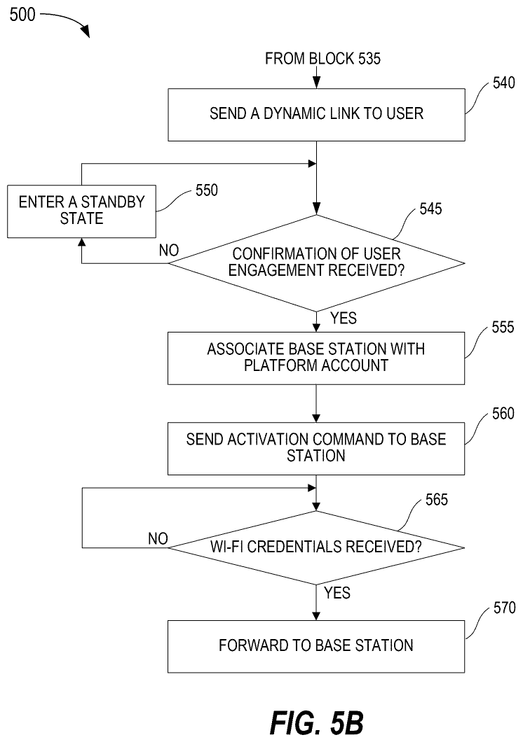

FIGS. 5A and 5B depict an example method 500 for a control platform to manage base station activation using pre-registered user information, according to some embodiments of the present disclosure. In some embodiments, the control platform may be implemented as a physical server or computing device, located on-premises or in a specific data center. In some embodiments, the control platform may be a cloud-based server hosted on a cloud computing infrastructures. In some embodiments, a hybrid approach may be used, combining physical servers for localized processing and data storage with cloud-based resources for third-party integrations.

At block 505, the control platform (e.g., 210 of FIG. 2) collects transaction details during the purchase process, including the customer's contact information (e.g., email, phone number, home address) and device-specific details (e.g., serial number, IMEI, SKU, MAC address). The information is stored in the platform's database for future reference during activation.

At block 510, the platform monitors for a connection request (e.g., 225 of FIG. 2) from a base station (e.g., 125 of FIGS. 1, 205 of FIGS. 2, 305 of FIG. 2). If a connection request is received, the method 600 proceeds to block 515. If no connection request is received, the platform continues waiting and monitors for new devices attempting to connect. In some embodiments, the connection request may include data needed for the platform to recognize and authenticate the device, such as the device's identifier (e.g., serial number or MAC address), its location information (e.g., GPS data), and other relevant details (e.g., firmware version, model number).

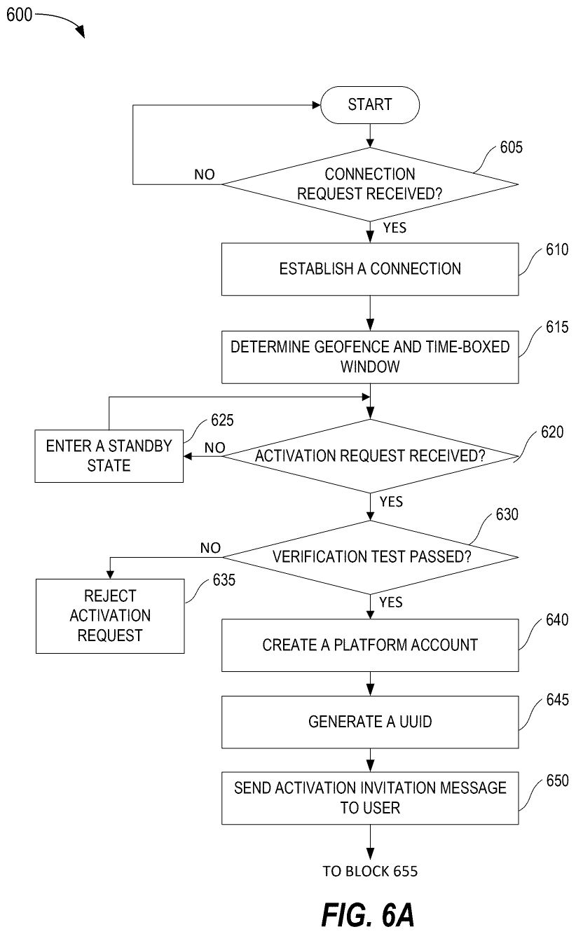

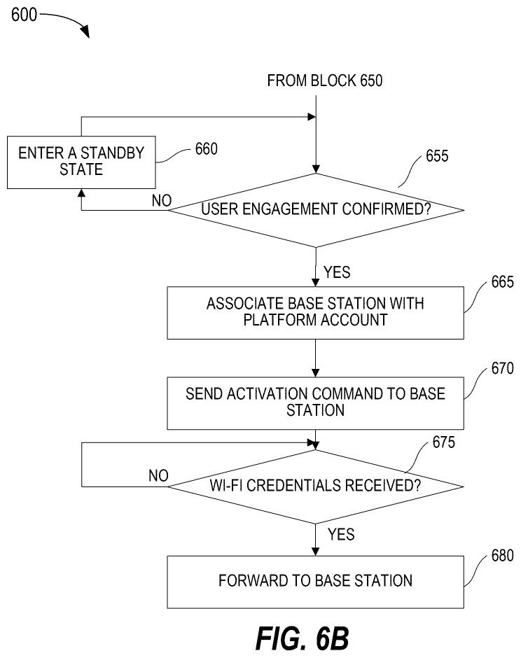

At block 515, the platform checks if the device details (e.g., serial number or MAC address) in the connection request match the pre-stored data collected during purchase. The pre-store data may include identifiers (e.g., serial number) of devices that have been sold, and their association with the purchaser's contact information (e.g., email or phone number). If a matching record is found, this indicates that the device is an authorized unit (and not a counterfeit) and is linked to a known customer. In this configuration, the method proceeds to block 525. If no matching record is found, the method 500 moves to block 520, where the platform switches to performing additional verification, such as checking geofence and time-boxed window parameters (as detailed in FIG. 6), to determine whether the activation request is valid.

At block 525, the platform sends a response (e.g., 235 of FIG. 2) to the base station, including an acknowledgment of the request and security credentials or tokens. Following the exchange, a communication channel is established using encryption protocols (e.g., HTTPS, TLS) to protect all subsequent interactions.

At block 530, the platform creates a platform account for the user using the pre-stored purchase information. The account serves as the central hub for managing the base station and associated IoT devices (e.g., home security sensors). In some embodiments, the platform may create the user's platform account after receiving the purchased-related information at block 505, even before the connection request is received at block 510.

At block 535, the platform assigns a UUID to the base station. The UUID servers as a globally unique reference for tracking and managing the device.

At block 540 (as depicted in FIG. 5B), the platform generates a dynamic link (e.g., URL) that includes the UUID assigned to the base station. The integration of the UUID into the dynamic link ties the activation process to the specific base station. Once the user clicks or opens the link, a response (including the UUID) is automatically sent to the platform, allowing the platform to identify the specific base station to be activated and proceed with the next step without requiring additional user inputs.

In some embodiments, the dynamic link may be included within an activation invitation message (e.g., 255 of FIG. 2) and sent to the user's device based on the contact information collected during the purchase process. The message may be delivered through various channels, such as emails, text messages, or app notifications, depending on the user's provided details. The activation invitation message may guide the user to initiate the activation process by clicking or opening the dynamic link. In some embodiments, the dynamic link may direct the user to confirm their engagement or register additional details (e.g., by creating a user account via a mobile application or website).

At block 545, the platform checks whether a confirmation message (e.g., 270 of FIG. 2) is received. The confirmation message is automatically triggered when the user clicks or opens the dynamic link included in the activation invitation message. The confirmation message represents the user's approval to proceed with activating the base station. In some embodiments, the confirmation message may include the UUID assigned to the base station, allowing the platform to identify the specific device to be activated without requiring further manual inputs from the user. If the confirmation is received, the method proceeds to block 555. If no confirmation is received, the platform enters a standby state and resends the dynamic link after a predefined interval.

At block 555, the platform associates the base station (identified by the UUID) with the platform account. If the user has registered a user account (e.g., via a mobile application or website), the platform may also link the base station and platform account with the user account.

At block 560, the platform sends an activation command (e.g., 280 of FIG. 2) to the base station. The command may include configuration instructions generated based on the information stored within the platform account and/or user account. These instructions customize the base station's settings to suit the monitored environment and the user's preferences (e.g., time zone settings, notification preferences, location-based features, and security settings).

At block 565, the platform checks whether Wi-Fi credentials (e.g., SSID and password) are received from the user through the app or website. If Wi-Fi credentials are received, the method 500 proceeds to block 570, where the platform forwards this information to the base station. The base station may then use this information to connect to the specified Wi-Fi network in the monitored environment (e.g., the user's home). If no Wi-Fi credentials are received, the platform continues to use cellular connection to communicate with the base station. In some embodiments, the platform may send a notification or prompt to the user via the application, email, or other communication channels. The notification may remind the user to provide Wi-Fi credentials for optimal (or at least improved) performance. In some embodiments, the platform may also maintain a log or status update in the user's platform account, indicating that the base station is operating without a Wi-Fi connection and relying on cellular communication.

FIGS. 6A and 6B depict an example method 600 for a control platform to manage base station activation using geofence and time-boxed window, according to some embodiments of the present disclosure. The example method 600 may be applied to embodiments where no purchase-related information, like customer contact details or the serial number of the purchased device, has been pre-stored on the platform. Such situations typically arise for retail customers who purchase the product off-the-shelf or through other channels where user information is not collected at the time of purchase. In these configurations, additional verification steps (e.g., geofencing and time-boxed windows) are needed to determine whether the activation request originates from a valid and trustworthy source.

As discussed above, in some embodiments, the control platform may be implemented as a physical server or computing device, located on-premises or in a specific data center. In some embodiments, the control platform may be a cloud-based server hosted on a cloud computing infrastructures. In some embodiments, a hybrid approach may be used, combining physical servers for localized processing and data storage with cloud-based resources for third-party integrations.

At block 605, the platform (e.g., 310 of FIG. 3) checks if a connection request (e.g., 330 of FIG. 3) from a base station (e.g., 305 of FIG. 3) is received. In some embodiments, the request may be sent when the base station is unboxed, causing the battery tab (e.g., 115 of FIG. 1) to be pulled off and activating the SIM card (e.g., 140 of FIG. 1) (which sends the connection request). In some embodiments, the request may be sent when the user manually powers on the base station, such as by pressing the power button. The request may include information like the unique identifier of the base station (e.g., serial number or MAC address) and location data (e.g., GPS coordinates). The location data may then be used by the platform to define a geofence for activation validation. If a connection request is received, the method 600 moves to block 610. If no request is received, the platform continues waiting and monitoring for incoming requests.

Since no pre-stored data is available (e.g., customer contact information), the platform cannot determine whether the base station is linked to a specific customer and obtain the relevant contact information (e.g., email, phone number, home address). Given this limitation, at block 610, the platform sends a response (e.g., 335 of FIG. 3) to the base station and establishes a communication channel (temporarily) without associating it with any specific user. This established channel allows the platform to continue interact with the base station with information protected (e.g., using encryption protocols like HTTPs or TLS).

At block 615, the platform defines a geofence based on the location data of the base station, shared in the connection request. The platform also establishes a time-boxed activation window. As used herein, the geofence refers to a virtual boundary around the base station's reported location. As used herein, the time-boxed activation window refers to a specific period starting when the connection request is received, during which activation requests are considered valid.

At block 620, the platform checks whether an activation request (e.g., 350 of FIG. 3) has been received from a user's device (e.g., 315 of FIG. 3). In some embodiments, the packaging of the base station may include instructions that guide the user on how to proceed with sending the activation request to the platform. These instructions may direct the user to download a mobile application or visit a website connected to the platform. In some embodiments, for convenience, the packaging may include a QR code that the user can scan with their mobile devices and access the application or website.

Once the user accesses the application or website, the user may be guided through the process of sending the activation request to the platform. In some embodiments, the user may also register a user account during this process and provide additional contact information (e.g., email, phone number, home address).

As depicted, if the activation request is received, the method 600 proceeds to block 630. If no activation request is received, the method 600 moves to block 625, where the platform enters a standby state and continues monitoring for incoming activation requests. If no activation request is received within a reasonable timeframe, in some embodiments, the platform may send a notification to the base station. This notification is intended to inform the user that no activation request has been received and request the user to take further actions (e.g., reviewing the packaging instructions, scanning the QR code, accessing the application or website to resend another request). In some embodiments, the notification may be displayed by the base station through its user interface (e.g., an LED indicator, display screen, or audio alert).

At block 630, the platform checks whether the activation request passes the verification test. The verification test includes two criteria: the location of the user device (included within the activation request) falls within the defined geofence; and the activation request is received within the defined time-boxed window. If the request satisfy both criteria, this indicates that the user device is likely in close proximity to the base station and sent immediately after powering on the base station. Therefore, the user device is likely an authorized device for initiating the activation process. The method proceeds to block 640. If the request fails the verification test (not meeting either criterion), the method 600 moves to block 635, where the platform sends a rejection message (e.g., 360-1 of FIG. 3) to the user's device, notifying the user that the activation attempt is unsuccessful. The user may retry to send another activation request within the geofence and time-boxed window.

At block 640, the platform creates a platform account for the user to manage the base station and other connected IoT devices (e.g., home security sensors).

At block 645, the platform assigns a UUID to the base station. The UUID is used to track and manage the base station throughout the device's lifecycle in the platform.

At block 650, the platform generates a PIN and includes the code into an activation invitation message (e.g., 360-2 of FIG. 3). The message is then sent back to the user device (e.g., via text message, email, or app notification). Upon receiving the code, the user manually enters the code on the base station, which then sends a confirmation message (e.g., 382 of FIG. 3) back to the platform for verification.

At block 655 (as depicted in FIG. 6B), the platform verifies the received code and confirms user engagement. If the PIN matches the one sent by the platform, it indicates that the user has successfully engaged with the activation process and approved the activation. The method 600 then proceeds to block 665. If the code does not match, the method 600 moves to block 660, where the platform enters a standby state and resends a new PIN code after a predefined interval to allow the user another attempt at activation.

At block 665, the platform associates the base station (identified by the UUID) with the user's platform account. In embodiments where the user registered a user account (e.g., via an app or website), the platform also link the base station and platform account with the user account.

At block 670, the platform sends an activation command (e.g., 390 of FIG. 3) to the base station. The command may include configuration instructions based on user preferences (e.g., information extracted from platform account and/or user account). At block 675, the platform checks if whether Wi-Fi credentials (e.g., SSID and password) are provided by the user through the application or website. If received, the method 600 proceeds to block 680, where the platform forwards this information to the base station, which connects to the specified Wi-Fi network in the monitored environment (e.g., the user's home). If no credentials are received, the platform continues using cellular connection for communication with the base station. In some embodiments, the platform may send a reminder to the user's device via email, text message, or other communication channels, asking the user to provide Wi-Fi credentials for improved performance. The reminder may include instructions or a direct link to the application or website where the credentials can be entered. In some embodiments, the platform may update the user's platform account with a log or status indicating that the base station is currently operating using cellular connection.

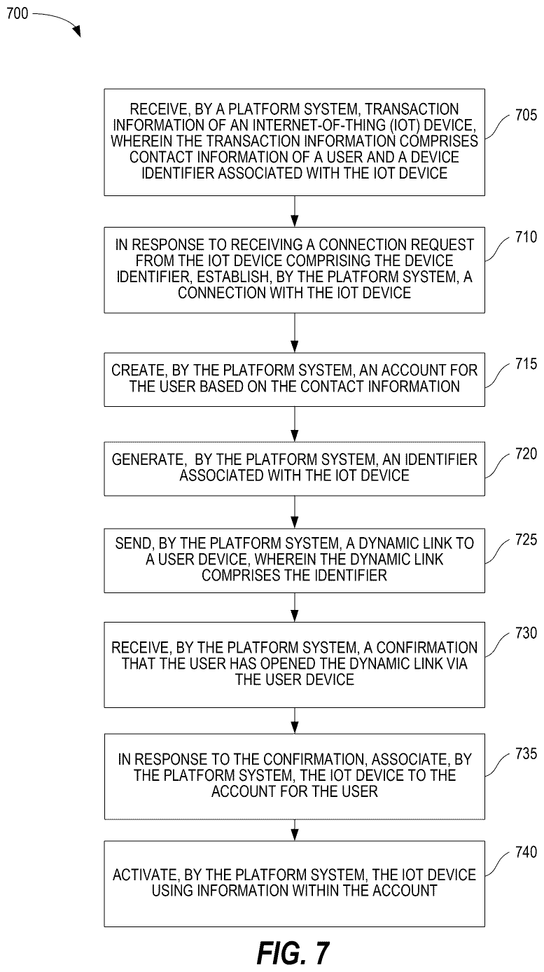

FIG. 7 is a flow diagram depicting an example method 700 for activating an IoT device for a registered user, according to some embodiments of the present disclosure.

At block 705, a platform system (e.g., 210 of FIG. 2) receives transaction information of an Internet-of-Things (IoT) device (e.g., 205 of FIG. 2), where the transaction information comprises contact information of a user and a device identifier associated with the IoT device.

At block 710, in response to receiving a connection request (e.g., 225 of FIG. 2) from the IoT device comprising the device identifier, the platform system establishes a connection (e.g., 240 of FIG. 2) with the IoT device.

At block 715, the platform system creates an account for the user based on the contact information (as depicted by step 245 of FIG. 2).

At block 720, the platform generates an identifier associated with the IoT device (as depicted by step 250 of FIG. 2).

At block 725, the platform sends a dynamic link (e.g., included within the activation invitation message 255 of FIG. 2) to a user device (e.g., 215 of FIG. 2), where the dynamic link comprises the identifier.

At block 730, the platform receives a confirmation (e.g., 270 of FIG. 2) that the user has opened the dynamic link via the user device.

At block 735, in response to the confirmation, the platform associates the IoT device to the account for the user (as depicted by step 275 of FIG. 2).

At block 740, the platform activates the IoT device using information within the account (as depicted by step 280 of FIG. 2).

In some embodiments, the platform may receive wireless credentials from the user via the user device (as depicted by step 285 of FIG. 2), and transmit the wireless credentials to the IoT device (as depicted by step 290 of FIG. 2), where the IoT device uses the wireless credentials to connect to a wireless network.

In some embodiments, prior to sending the connection request, the IoT device may be enclosed within a packaging, the packaging comprising a battery tab (e.g., 115 of FIG. 1) connected to a lid (e.g., 120 of FIG. 1) of the packaging, and the battery tab may be pulled from the IoT device as the lid of the packaging is opened.

In some embodiments, the connection request may be triggered by activation of a subscriber identity module (SIM) card (e.g., 140 of FIG. 1) integrated with the IoT device after the IoT device is powered on.

In some embodiments, the confirmation may comprise the identifier extracted from the dynamic link.

In some embodiments, the dynamic link may further direct the user to either download a software application or open a website to register a user account. The platform may, in response to the confirmation, associate the account created on the platform system with the user account registered through the software application or the website.

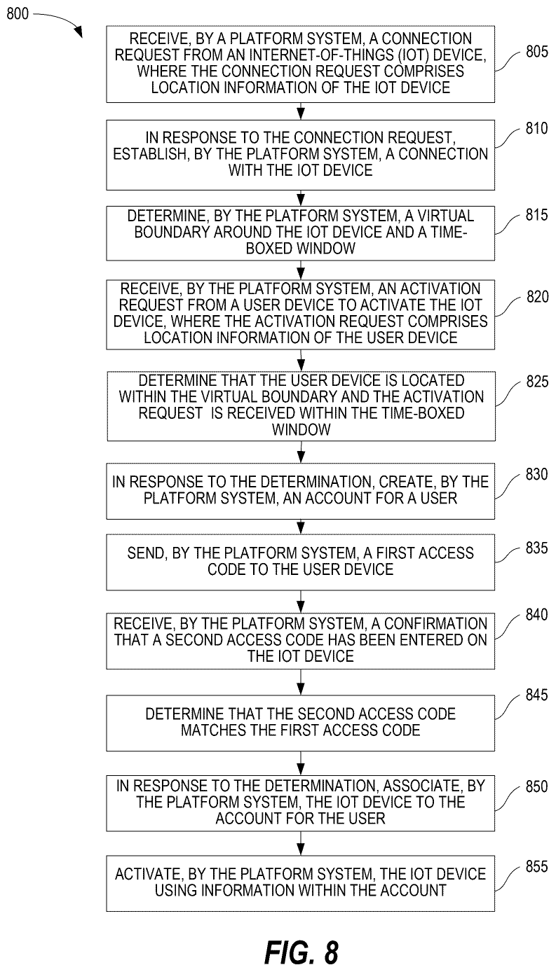

FIG. 8 is a flow diagram depicting an example method 800 for activating an IoT device for a retail user, according to some embodiments of the present disclosure.

At block 805, a platform system (e.g., 310 of FIG. 3) receives a connection request (e.g., 330 of FIG. 3) from an Internet-of-Things (IoT) device, where the connection request comprises location information of the IoT device.

At block 810, in response to the connection request, the platform system establishes a connection (e.g., 340 of FIG. 3) with the IoT device.

At block 815, the platform system determines a virtual boundary around the IoT device and a time-boxed window (as depicted by step 345 of FIG. 3).

At block 820, the platform system receives an activation request (e.g., 350 of FIG. 3) from a user device (e.g., 315 of FIG. 3) to activate the IoT device, where the activation request comprises location information of the user device.

At block 825, the platform system determines that the user device is located within the virtual boundary and the activation request is received within the time-boxed window.

At block 830, in response to the determination, the platform system creates an account for a user (as depicted by step 365 of FIG. 3).

At block 835, the platform system sends a first access code (e.g., included within an activation invitation message 360-2 of FIG. 3) to the user device.

At block 840, the platform system receives a confirmation (e.g., 382 of FIG. 3) that a second access code has been entered on the IoT device.

At block 845, the platform determines that the second access code matches the first access code.

At block 850, in response to the determination, the platform system associates the IoT device to the account for the user (as depicted by step 385 of FIG. 3).

At block 855, the platform system activates the IoT device using information within the account (as depicted by step 390 of FIG. 3).

In some embodiments, the activation request from the user device may be sent through a software application or a website, and, to send the activation request, the user may register a user account through the software application or website and provides contact information.

In some embodiments, in response to the confirmation, the platform system may associate the account created on the platform system with the user account registered through the software application or the website.

In some embodiments, the virtual boundary may comprise a geofence that defines a boundary around the IoT device based on the location information of the IoT device.

In some embodiments, the time-box window may comprise a limited period during which activation of the IoT device is permitted.

In some embodiments, the platform system may receive wireless credentials from the user via the user device (as depicted by step 395 of FIG. 3), and transmit the wireless credentials to the IoT device (as depicted by step 397 of FIG. 3, where the IoT device uses the wireless credentials to connect to a wireless network.

In some embodiments, the IoT device may be powered on as packaging of the IoT device is opened by attaching a battery tab (e.g., 115 of FIG. 1) to a lid (e.g., 120 of FIG. 1) of the packaging, and the battery tab is configured to be pulled from the IoT device as the lid of the packaging is opened.

In some embodiments, the connection request may be triggered by activation of a subscriber identity module (SIM) card (e.g., 140 of FIG. 1) integrated with the IoT device after the IoT device is powered on.

In some embodiments, the platform system may receive a second connection request from a second user device to activate the IoT device, where the second connection request comprises location information of the second user device. The platform system may determine that the second user device is not located within the virtual boundary or the second connection request is received within the time-boxed window. In response to the determination, the platform system may send a rejection (e.g., 360-1 of FIG. 3) to the second user device, where the rejection comprises at least one of reasons for the rejection and instructions to retry within the virtual boundary and the time-boxed window.

In some embodiments, the platform system may receive a second connection request from a second user device to activate the IoT device, where the second connection request comprises location information of the second user device. The platform may determine that the second user device is located within the virtual boundary and the second connection request is received within the time-boxed window. In response to the determination, the platform system may create an account for a second user. The platform may then send a third access code to the second user device, receive a confirmation that a fourth access code has been entered on the IoT device, and determine that the third access code does not match the fourth access code. In response to the determination, the platform enter a standby state and resend a fifth access code after a defined time interval.

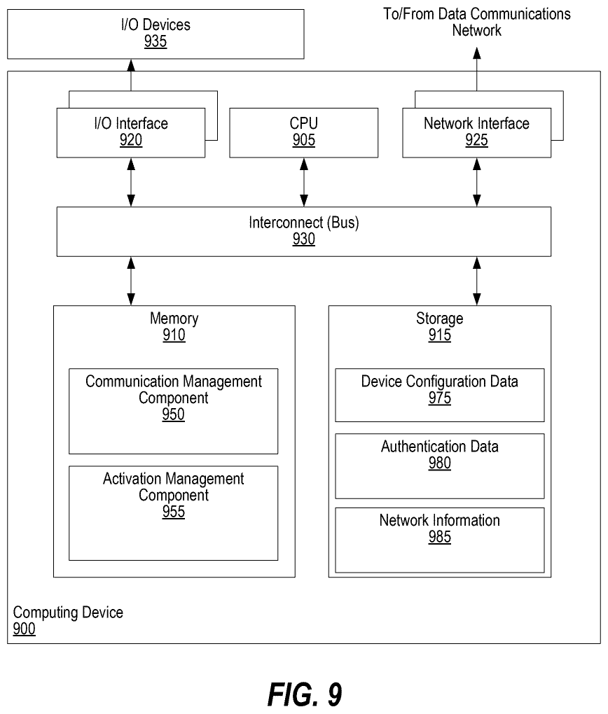

FIG. 9 depicts an example computing device 900 configured to perform various aspects of the present disclosure, according to some embodiments of the present disclosure. In some embodiment, the computing device 900 may correspond to the base station 125 as depicted in FIG. 1, base station 205 as depicted in FIG. 2, base station 305 as depicted in FIG. 3. Although depicted as a physical device, in some embodiments, the computing device 900 may be implemented using virtual device(s), and/or across a number of devices (e.g., in a cloud environment).

As illustrated, the computing device 900 includes a CPU 905, memory 910, storage 915, one or more network interfaces 925, and one or more I/O interfaces 920. In the illustrated embodiment, the CPU 905 retrieves and executes programming instructions stored in memory 910, as well as stores and retrieves application data residing in storage 915. The CPU 905 is generally representative of a single CPU and/or GPU, multiple CPUs and/or GPUs, a single CPU and/or GPU having multiple processing cores, and the like. The memory 910 is generally considered to be representative of a random access memory. Storage 915 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 935 (e.g., home security sensors) are connected via the I/O interface(s) 920. Further, via the network interface 925, the computing device 900 can be communicatively coupled with one or more other devices and components (e.g., via a network, which may include the Internet, local network(s), and the like). As illustrated, the CPU 905, memory 910, storage 915, network interface(s) 925, and I/O interface(s) 920 are communicatively coupled by one or more buses 930.

In the illustrated embodiment, the memory 910 includes a communication management component 950 and an activation management component 955. Although depicted as discrete components for conceptual clarity, in some embodiments, the operations of the depicted components (and others not illustrated) may be combined or distributed across any number of components. Further, although depicted as software residing in memory 910, in some embodiments, the operations of the depicted components (and others not illustrated) may be implemented using hardware, software, or a combination of hardware and software.

In one embodiment, the communication management component 950 may handle interactions with the control platform (e.g., 210 of FIG. 2 or 310 of FIG. 3) to establish a communication channel. More specifically, the communication management component 950 may send a connection request to the platform via an integrated SIM card (e.g., 140 of FIG. 1). When a response is sent by the platform, the communication management component 950 may interpret the response and extract the security token and configuration details. With the extracted information, the communication management component 950 may establish an encrypted communication channel with the platform, using protocols like HTTPS or TLS. The encrypted communication channel may then be used for subsequent data exchanges between the platform and the base station.

In one embodiment, the activation management component 955 may manage the activation process and initial device setup. More specifically, the activation management component 955 may monitor for activation commands from the platform and configure device settings (e.g., time zones, notification preferences, security parameters) based on the instructions received. When Wi-Fi credentials are received, the activation and setup component 955 may manage the connection to the specified Wi-Fi network and update the connection status with the platform.

In the illustrated example, the storage 915 may contain data for effective operations of the computing device 900 within the IoT ecosystem. The data may include, but is not limited to, device configuration data 975 (e.g., time zones, notification preferences, security settings), authentication data 980 (e.g., encryption keys, tokens, or certificates used for secure communication), and network information 985 (e.g., Wi-Fi credentials, cellular network logs). In some embodiments, the aforementioned data may be saved in a remote database that connects to the computing device 900 via a network (e.g., the Internet).

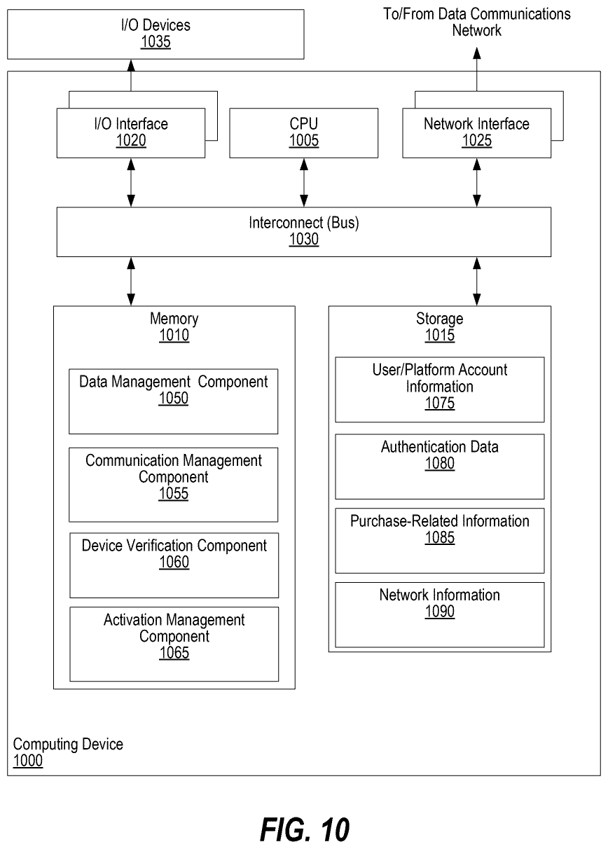

FIG. 10 depicts an example computing device 1000 configured to perform various aspects of the present disclosure, according to some embodiments of the present disclosure. In some embodiment, the computing device 1000 may correspond to the platform 210 as depicted in FIG. 2, the platform 310 as depicted in FIG. 3. Although depicted as a physical device, in some embodiments, the computing device 1000 may be implemented using virtual device(s), and/or across a number of devices (e.g., in a cloud environment).

As illustrated, the computing device 1000 includes a CPU 1005, memory 1010, storage 1015, one or more network interfaces 1025, and one or more I/O interfaces 1020. In the illustrated embodiment, the CPU 1005 retrieves and executes programming instructions stored in memory 1010, as well as stores and retrieves application data residing in storage 1015. The CPU 1005 is generally representative of a single CPU and/or GPU, multiple CPUs and/or GPUs, a single CPU and/or GPU having multiple processing cores, and the like. The memory 1010 is generally considered to be representative of a random access memory. Storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 1035 (e.g., base station 205 of FIG. 2, user device 215 of FIG. 2. base station 305 of FIG. 3, user device 315 of FIG. 3) are connected via the I/O interface(s) 1020. Further, via the network interface 1025, the computing device 1000 can be communicatively coupled with one or more other devices and components (e.g., via a network, which may include the Internet, local network(s), and the like). As illustrated, the CPU 1005, memory 1010, storage 1015, network interface(s) 1025, and I/O interface(s) 1020 are communicatively coupled by one or more buses 1030.

In the illustrated embodiment, the memory 1010 includes a data management component 1050, a communication management component 1055, a device verification component 1060, and an activation management component 1065. Although depicted as discrete components for conceptual clarity, in some embodiments, the operations of the depicted components (and others not illustrated) may be combined or distributed across any number of components. Further, although depicted as software residing in memory 1010, in some embodiments, the operations of the depicted components (and others not illustrated) may be implemented using hardware, software, or a combination of hardware and software.

In one embodiment, the data management component 1050 may store and manage purchase-related data collected before initiating activation (e.g., through online purchase). The purchase-related data may include customer contact information (e.g., email, phone number, home address) provided at the time of purchase and associated device-specific identifiers (e.g., serial number, IMEI, SKU). In some embodiments, the data management component 1050 may handle pre-registration of platform accounts based on the purchase-related data.

In one embodiment, the communication management component 1055 may handle interactions with the base station (e.g., 205 of FIG. 2 or 305 of FIG. 3) and user's device (e.g., 215 of FIG. 2 or 315 of FIG. 3). More specifically, the communication management component 1055 may receive and process connection requests from the base station (e.g., via SIM card). The communication management component 1055 may compare device-specific details (e.g., serial number or IMEI) included within the connection request against pre-stored purchase records (e.g., online purchases). When a matching record is found, the communication management component 1055 may send connection responses to the base station and establish a secure communication channel. The encrypted communication channel may then be used for subsequent data exchanges between the platform and the base station. In embodiments where purchase information is not available (e.g., retail purchases) and user sends activation requests to the platform, the communication management component 1055 may process the activation requests and provide the data to the device verification component 1060 for further analysis.

In one embodiment, the device verification component 1060 may verify the activation request using the defined geofence and time-boxed window. If the activation request satisfy both criteria, such as that the user device sending the activation request is located within the geofence and the request is received within the defined time-boxed window, it is considered a valid request. The device verification component 1060 may then instruct the activation management component 1065 to prepare the next steps, including creating platform accounts, assigning UUIDs, and sending activation commands. If the request fails either criterion, such as that the user device sending the activation request is located outside the geofence and the request is received outside the defined time-boxed window, it is considered an invalid request. The device verification component 1060 may request the communication management component 1055 to send a rejection message to the user's device.

In one embodiment, the activation management component 1065 may handle the process of activating the base station, from account creation and UUID assignment to device association and setup. More specifically, the activation management component 1065 may create platform accounts for users, either at the time of purchase or during activation. The activation management component 1065 may generate a UUID for the base station and embed the UUID within a dynamic link. The activation management component 1065 may then send the dynamic link to the user for activation confirmation. Upon receiving confirmation from the user, the activation management component 1065 may link the base station (identified by UUID) to the user's platform account (or user account, if applicable) and send activation commands and configuration instructions to the base station.

In the illustrated example, the storage 1015 may include data for managing IoT device activation. The data may include, but are not limited to, user/platform account information 1075 (e.g., email, phone number, home address, notification preferences, privacy and security requirements), authentication data 1080 (e.g., encryption keys, tokens, or certificate used for secure communication), purchase-related information 1085 (e.g., transaction details, device-specific identifiers and contact details linked to purchases), network information 1090 (e.g., Wi-Fi credentials, cellular network logs). In some embodiments, the aforementioned data may be saved in a remote database that connects to the computing device 1000 via a network (e.g., the Internet).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a platform system, transaction information of an Internet-of-Things (IoT) device, wherein the transaction information comprises contact information of a user and a device identifier associated with the IoT device;
in response to receiving a connection request from the IoT device comprising the device identifier, establishing, by the platform system, a connection with the IoT device;
creating, by the platform system, an account for the user based on the contact information;
generating, by the platform system, an identifier associated with the IoT device;
sending, by the platform system, a dynamic link to a user device, wherein the dynamic link comprises the identifier;
receiving, by the platform system, a confirmation that the user has opened the dynamic link via the user device;
in response to the confirmation, associating, by the platform system, the IoT device to the account for the user; and
activating, by the platform system, the IoT device using information within the account.

2. The method of claim 1, further comprising:
receiving, by the platform system, wireless credentials from the user via the user device; and
transmitting, by the platform system, the wireless credentials to the IoT device, wherein the IoT device uses the wireless credentials to connect to a wireless network.

3. The method of claim 1, wherein, prior to sending the connection request, the IoT device is enclosed within a packaging, the packaging comprising a battery tab connected to a lid of the packaging, and wherein the battery tab is pulled from the IoT device as the lid of the packaging is opened.

4. The method of claim 1, wherein the connection request is triggered by activation of a subscriber identity module (SIM) card integrated with the IoT device after the IoT device is powered on.

5. The method of claim 1, wherein the confirmation comprises the identifier extracted from the dynamic link.

6. The method of claim 1, wherein the dynamic link further directs the user to either download a software application or open a website to register a user account, and the method further comprises:
in response to the confirmation, associating, by the platform system, the account created on the platform system with the user account registered through the software application or the website.

7. A method, comprising:
receiving, by a platform system, a connection request from an Internet-of-Things (IoT) device, wherein the connection request comprises location information of the IoT device;
in response to the connection request, establishing, by the platform system, a connection with the IoT device;
determining, by the platform system, a virtual boundary around the IoT device and a time-boxed window;
receiving, by the platform system, an activation request from a user device to activate the IoT device, wherein the activation request comprises location information of the user device;
determining that the user device is located within the virtual boundary and the activation request is received within the time-boxed window;
in response to the determination, creating, by the platform system, an account for a user;
sending, by the platform system, a first access code to the user device;
receiving, by the platform system, a confirmation that a second access code has been entered on the IoT device;
determining that the second access code matches the first access code;
in response to the determination, associating, by the platform system, the IoT device to the account for the user; and
activating, by the platform system, the IoT device using information within the account.

8. The method of claim 7, wherein the activation request from the user device is sent through a software application or a website, and wherein, to send the activation request, the user registers a user account through the software application or website and provides contact information.

9. The method of claim 8, further comprising:
in response to the determination, associating, by the platform system, the account created on the platform system with the user account registered through the software application or the website.

10. The method of claim 7, wherein the virtual boundary comprises a geofence that defines a boundary around the IoT device based on the location information of the IoT device.

11. The method of claim 7, wherein the time-box window comprises a limited period during which activation of the IoT device is permitted.

12. The method of claim 7, further comprising:
receiving, by the platform system, wireless credentials from the user via the user device; and
transmitting, by the platform system, the wireless credentials to the IoT device, wherein the IoT device uses the wireless credentials to connect to a wireless network.

13. The method of claim 7, wherein the IoT device is powered on as packaging of the IoT device is opened by attaching a battery tab to a lid of the packaging, and wherein the battery tab is configured to be pulled from the IoT device as the lid of the packaging is opened.

14. The method of claim 7, wherein the connection request is triggered by activation of a subscriber identity module (SIM) card integrated with the IoT device after the IoT device is powered on.

15. The method of claim 7, further comprising:
receiving, by the platform system, a second connection request from a second user device to activate the IoT device, wherein the second connection request comprises location information of the second user device;
determining that the second user device is not located within the virtual boundary or the second connection request is received within the time-boxed window; and
in response to the determination, sending, by the platform system, a rejection to the second user device, wherein the rejection comprises at least one of reasons for the rejection and instructions to retry within the virtual boundary and the time-boxed window.

16. The method of claim 7, further comprising:
receiving, by the platform system, a second connection request from a second user device to activate the IoT device, wherein the second connection request comprises location information of the second user device;
determining that the second user device is located within the virtual boundary and the second connection request is received within the time-boxed window;
in response to the determination, creating, by the platform system, an account for a second user;
sending, by the platform system, a third access code to the second user device;
receiving, by the platform system, a confirmation that a fourth access code has been entered on the IoT device;
determining that the third access code does not match the fourth access code; and
in response to the determination, entering, by the platform, a standby state and resending a fifth access code after a defined time interval.

17. A packaging of an Internet-of-Things (IoT) device, comprising:
a battery tab attached to a lid of the packaging; and
a subscriber identity module (SIM) card integrated within the IoT device,
wherein, when the packaging is opened by a user, the battery tab is automatically pulled from the IoT device, activating a battery to power on the IoT device, and
wherein, upon being powered on, the IoT device activates the SIM card to send a connection request to a platform system to initiate an activation process.

18. The packaging of claim 17, wherein, upon receiving the connection request from the IoT device, the platform system performs operations comprising:
establishing a connection with the IoT device;
creating an account for the user based on contact information of the user received at a time of purchase;
generating an identifier associated with the IoT device;
sending a dynamic link to a user device, wherein the dynamic link comprises the identifier;
associating the IoT device to the account for the user upon receiving a confirmation indicating that the user has opened the dynamic link via the user device; and
activating the IoT device using information within the account.

19. The packaging of claim 17, wherein the connection request comprises location information of the IoT device, and wherein, upon receiving the connection request from the IoT device, the platform system performs operations comprising:
establishing a connection with the IoT device;
determining a virtual boundary around the IoT device and a time-boxed window;
receiving an activation request from a user device to activate the IoT device, wherein the activation request comprises location information of the user device;
creating an account for the user upon determining that the user device is located within the virtual boundary and the activation request is received within the time-boxed window;
generating an identifier associated with the IoT device;
sending a first access code to the user device;
receiving a confirmation that a second access code has been entered on the IoT device;
determining that the second access code matches the first access code;
in response to the determination, associating the IoT device to the account for the user; and
activating the IoT device using information within the account.

20. The packaging of claim 17, wherein the connection request comprises location information of the IoT device, and wherein, upon receiving the connection request, the platform system performs operations comprising:
establishing a connection with the IoT device;
determining a virtual boundary around the IoT device and a time-boxed window;
receiving an activation request from a user device to activate the IoT device, wherein the activation request comprises location information of the user device; and
sending a rejection to the user device upon determining that the user device is not located within the virtual boundary or the activation request is received within the time-boxed window.
